(19) United States
(12) Patent Application Publication
(10) Pub. No.: US 2007/0172792 A1
(43) Pub. Date: Jul. 26, 2007

(54) Method of dental impression taking

(76) Inventors: Stephan Lampl, Luchingen (CH); Dierk Lubbers, Eichberg (CH)

Correspondence Address: KATTEN MUCHIN ROSENMAN LLP, 575 MADISON AVENUE, NEW YORK, NY, 10022-2585, US

(21) Appl. No.: 11/637,204

(22) Filed: Dec. 11, 2006

Related U.S. Application Data
(60) Provisional application No. 60/750,624, filed on Dec. 15, 2005.

(51) Int. Cl. A61C 5/14

(52) U.S. Cl. 433/136

(57) ABSTRACT

The invention relates to a method of dental impression taking, comprising the step of applying a polymeric material at least partially to the region to be reproduced by the impression, wherein the polymeric material is translucent, and accordingly suitable polymeric materials.

### CROSS-REFERENCE TO RELATED APPLICATIONS

This application claims priority from U.S. Provisional Application No. 60/750,624 filed on Dec. 15, 2005, incorporated herein by reference.

### FIELD OF THE INVENTION

The present invention relates to the technical field of dental impression taking and a polymeric material which has been found especially useful therefore.

### BACKGROUND OF THE INVENTION

In the course of various dental applications, e.g. in dental restoration, it is necessary to take an impression of the patient's dental situation, in order to provide the dentist with a 3D model. Such a 3D model needs to resemble the dental situation as exactly as possible in order to provide the dentist with a suitable basis e.g. for a satisfying restoration being prepared, such as a crown, a bridge, or the like.

A common problem in dental impression taking is a loss in precision of the mold due to irregularities, e.g. inclusion of air bubbles within or under the impression material, resulting in non-molded areas, which are not reproduced. Such non-molded areas are afterwards either extrapolated by the dentist, if possible (often resulting in non-satisfactory results) or the impression taking must be performed once again in the worst case, causing inconvenience to both the patient and the dentist. In the state of the art, inclusion of air bubbles within or under the impression material was tried to be eliminated by various approaches, e.g. by modifying the flow-characteristics of the impression material, or by using special impression trays, which aims to eliminate such air inclusions by applying reduced pressure to the impression region. However, all these approaches do not allow for a reliable elimination of said air inclusions under all circumstances, and/or afford complicated impression tray devices.

### BRIEF SUMMARY OF THE INVENTION

It is an object of the present invention to overcome the drawbacks of the prior art, especially to more reliably allow for the elimination of irregularities, e.g. the inclusion of air bubbles within and/or under an impression material, in order to more reliably allow for a highly detailed impression taking.

This object has been solved by a method of dental impression taking and a polymeric material therefore, as outlined below.

According to the invention, a method of dental impression taking comprises the step of applying a polymeric material at least partially to the region to be reproduced by the impression, wherein the polymeric material is translucent. Preferably, the translucency of the polymeric material is in the range from about 30% to about 100%, preferably ≧40%, and most preferably ≧50%. Preferably, the method of impression taking comprises the additional steps of:
identifying an irregularity, especially air inclusion(s) within and/or under said translucent polymeric material; and
eliminating said irregularities before hardening of said translucent polymeric material.

### DETAILED DESCRIPTION OF THE INVENTION

The use of a polymeric, translucent material in dental impression taking is not previously known. In contrast, commonly used impression materials such as silicon materials are opaque, mostly due to (especially relatively high contents of) filling materials. However, according to the invention, the above-mentioned drawbacks of the prior art have surprisingly been overcome by using a translucent impression material, because a sufficient translucency allows for easy identification of possible air inclusion(s) . Such identified air inclusion(s) can then easily be eliminated before hardening of the applied impression material, e.g. by simply sticking and/or slightly turning the application tip of common dispensers of impression material at the air inclusion(s), whereupon the air inclusion(s) can be easily eliminated.

Preferably, the process of dental impression taking according to the invention is a process chosen from the group consisting of two-material-two-phase processes, two-material-one-phase processes, and one-material-one-phase processes. These techniques are known by those skilled in the art. According to the two-material-two-phase process a crude impression is taken with a kneadable or heavy body impression material, which is subsequently additionally manipulated e.g. with cutting instruments outside the patient's mouth, and finally a correction impression material is applied onto said manipulated crude impression again into the patient's mouth to a final impression mold. According to the invention, a translucent impression material is used at least as the correction impression material; if wanted and found appropriate in a special case, both impression materials may be translucent.

According to the two-material-one-phase process, two impression materials are applied at the same time, the one afar from the tooth and the other adjacent to the tooth. Further according to the invention, a translucent impression material is used adjacent to the tooth; if wanted and found appropriate in a special case, both impression materials may be translucent.

According to the one-material-one-phase process one and the same material is applied in an impression tray and additionally e.g. with a syringe. According to the invention, a translucent impression material is used.

According to the invention there is provided a polymeric material for dental applications, especially for impression taking, characterized in that it exhibits the following features:
a translucency in the range of about 30% to about 100%, preferably ≧40%, and most preferably ≧50%;
a shore A hardness according to DIN 53505 (Ausgabe 08/1973) in the range of about 20 to about 70, preferably from about 30 to about 60, and most preferably from about 45 to 55;
a tensile strength according to DIN 53504 (Ausgabe 05/1969) in the range of about 0.2 MPa to about 7 MPa, preferably from about 1 MPa to about 6 MPa, and most preferably from about 1.5 MPa to about 5.5 MPa.

Translucency in the above-mentioned ranges has been proven sufficient, the high translucencies being ideal for visual control of the applied material for the presence of air bubbles. The sample is prepared by filling the uncured material in a stainless steel form of 25*20* 1 mm, and pressing off excessive material with a glass plate. After curing at 23° C., the sample is taken out.

Translucency of the polymeric material is determined through the 1 mm dimension of the sample with a BaSO₄ white background in a US/VIS spectrophotometer (LAMBDA 16, Perkin Elmer) with “ULBRICHTscher Kugel”. The background correction is measured against a BaSO4 white standard.

The above-mentioned ranges of shore A hardness according to DIN 30 53505 and tensile strength according to DIN 53504 have proven excellent for putting into practice the materials according to all embodiments of the present invention. A person skilled in the art can easily choose and adapt the shore A hardness and the tensile strength in the above-mentioned ranges, by routine laboratory techniques, e.g. incorporation of suitable additives which do not hamper the above-mentioned translucency. If, for example, fillers are needed to be incorporated, they must be accordingly chosen (i.e., suitably fine dispersed) and in such an amount, that the translucency requirement is fulfilled.

According to yet another preferred embodiment, the material exhibits a consistency according to DIN ISO 4823:2000 of type 1 to type 3, preferably of type 2 or type 3.

Currently, hydrophilic impression materials are preferred in the art. Accordingly, the material according to the invention preferably exhibits a wetting angle of contact of less than about 50° after 2 minutes. However, the invention is not limited to hydrophilic materials, i.e. angles of contact of more than about 50° after 2 minutes, especially of more than about 90° after 2 minutes may also be appropriate for some applications.

The angle of contact is determined as follows: a polymeric sample is prepared in a brass frame of 65*25*3 mm size and cured therein for about 10 minutes. Five minutes after detaching the sample from the frame, a droplet of deionized water is dropped onto the sample surface, and the angle of contact is determined with a drop shape analysis system DSA 10 of KRUSS GmbH, Hamburg, Germany. If so desired, the person of routine skill in the art will easily achieve and/or fine tune a suitable angle of contact e.g. by incorporating surfactants of common practice in the art, e.g. branched-nonylphenol ethoxylate (IGEPAL BC4), etc.

According to an especially preferred embodiment of the present invention, the polymeric material is a silicon-based material, preferably an addition-crosslinked silicon material. It is understood that condensation-crosslinked silicon materials are also appropriate.

As used here and henceforth, the term “addition-crosslinked” or “addition-crosslinkable” means that the polymer comprises at least one functional group which may react with a crosslinking agent via an addition reaction. A typical example is that the polymer comprises at least one vinyl group, preferably two vinyl groups, which may undergo an electrophilic addition reaction with an appropriate crosslinking agent. Preferably, these vinyl groups are terminal.

As used here and henceforth, the term “condensation-crosslinked” or “condensation-crosslinkable” means that the polymer comprises at least one functional group which may react with a crosslinking agent via a condensation reaction. A typical example is that the polymer comprises at least one hydroxyl group, preferably two hydroxyl groups, which may undergo a condensation reaction with an appropriate crosslinking agent, for example, a crosslinking agent comprising alkoxy silicates.

More precisely, the polymeric material is or comprises a polyorganosiloxane, comprising building blocks suitably chosen from (but not necessarily comprising all of them) [M] (R₃SiO_{1/2}), [D] (R₂SiO_{2/2}), [T] (RSiO_{3/2}), and Q (SiO _{4/2}). The polyorganosiloxane may be linear, branched, cyclic and/or preferably crosslinked. The polyorganosiloxane is preferably modified by hydrosilylation, i.e. the addition of silanes and/or (poly) (organo)siloxanes comprising Si,H bonds to unsaturated groups, e.g. the vinyl groups of the above-mentioned polyorganosiloxanes. A person skilled in the art will readily choose a suitable composition of a polyorganosiloxane in order to meet the above-defined functional requirements of the polymeric material.

Alternatively, the polymeric material may also be a polyether-based material. Especially preferred is an aziridine-crosslinked polyether material. It is evident to the one skilled in the art, how to adjust the functional requirements as outlined above in the context of silicon-based material also for a polyether-based material.

Moreover, the molecular weight of the polymeric material is chosen such that the required shore A hardness and tensile strength are obtained. Optionally additives such as rheology modifiers may be added for adjustment of the said parameters as it is known to those skilled in the art. Especially dyes or pigments (such as e.g. fluorescent Pigments e.g. Lumilux Blau LZ (Omya AG), or glimmer pigments such as Timica Extra Bright 1500 (Mimox (LCW))) may be added in suitable amounts to the composition as long as the translucency and the other critical parameters as outlined above are not hampered. Moreover, fillers may suitably be added to the composition as long as the translucency and the other critical parameters as outlined above are not hampered, e.g. finely dispersed fillers, preferably nanofillers (e.g. Aerosil) and/or fillers which inherently exhibit a suitable refractive index (e.g. MgF₂). The Viscosity of the uncured material is suitably adjusted in the range of about 0.5 to about 500 Pa*s, preferably about to about 400 Pa*s, more Preferably about 100 to about 300 Pa*s, as measured according to Brookfield In any case, the rheology of the mixture to be applied is adjusted to allow for application by conventional dispensers, e.g. manually operated double chamber cartridges.

In yet another aspect of the present invention there is provided a kit of parts, comprising a translucent polymeric material preferably as outlined above, and a further polymeric, preferably translucent material. Such a kit of parts can be manufactured and shipped as it is current state of the art with all one-phase and two-phase processes in dental impression taking as described above. According to the invention, however, at least one or both polymeric materials are translucent.

According to another aspect of the present invention, the material according to the invention is used for the preparation of a dental impression chosen from the group consisting of (i) a key for temporary or definitive composite crowns, telescope crowns or bridges; (ii) a key for composite facings or veneers; (iii) a positioning key for orthodontic brackets; (iv) a positioning key prior to insertion of a dental implant; (v) an implant template matrix; and (vi) a (pre)impression for build-up of anterior and posterior teeth in restorative dentistry.

All the above-mentioned applications may exploit the same inherent advantages of a translucent material: Firstly, irregularities, bubbles or the like can be easily identified and eliminated before hardening. Secondly, the translucency of the material also allows for light-hardening of a suitably chosen, light-curing further material subsequently filled into the impression (e.g. to prepare a final model) by simply irradiating through the translucent material.

The invention will now be explained in more detail by a detailed description of preferred embodiments. However, in no way is the invention limited to only these embodiments.

### EXAMPLES

1. Compositions

The following two-component polymeric silicon materials were prepared:

### Example 1

“Light Body” (SiH/Vinyl: 1.94)
Base Paste:

| | |
|---|---|
| 70.00 g | Silopren Base Mixture P300 from GE Bayer |
| | (0.05 mmol Vinyl/g) |
| 9.00 g | Silopren Crosslinker 4.3 from GE Bayer |
| | (4.20 mmol SiH/g) |
| 2.00 g | Silopren Chain Extender TP 3359 from GE Bayer |
| | (1.42 mmol SiH/g) |
| 9.00 g | Vinylsilicon VS 50 from Hanse Chemical, an alpha/omega- |
| | Divinylpolydimethylsiloxan with 50 mPa * s |
| | (0.63 mmol Vinyl/g) |
| 10.00 g | Vinylsilicon VS 10,000 from Hanse Chemical, an alpha/omega- |
| | Divinylpolydimethylsiloxan with 10,000 mPa * s |
| | (0.05 mmol Vinyl/g) |

Catalyst Paste:

| | |
|---|---|
| 70.00 g | Silopren Base Mixture P300 from GE Bayer |
| | (0.05 mmol Vinyl/g) |
| 0.35 g | Catalyst preparation (90 weight % alpha/omega |
| | divinylpolydimethylsiloxan with 1,000 mPa * s; 10 weight % |
| | catalyst complex Karstedt; corresponding to 4 |
| | weight % pure Pt) |
| | (0.53 mmol Vinyl/g) |
| 10.00 g | Vinylsilicon VS 50 from Hanse Chemical, an alpha/omega |
| | Divinylpolydimethylsiloxan with 50 mPa * s |
| | (0.63 mmol Vinyl/g) |
| 0.025 g | Inhibitor PTS-I 27 (DVTMDS) from Wacker Chemical |
| | (10.75 mmol Vinyl/g) |
| 19.70 g | Vinylsilicon VS 10,000 from Hanse Chemical, an alpha/omega- |
| | Divinylpolydimethylsiloxan with 10,000 mPa * s |
| | (0.05 mmol Vinyl/g) |

### Example 2

“Regular Body” (SiH/Vinyl: 1.87)
Base Paste:

| | |
|---|---|
| 40.00 g | Silopren Base Mixture P1,300 from GE Bayer |
| | (0.06 mmol Vinyl/g) |
| 9.00 g | Silopren Crosslinker 4.3 from GE Bayer |
| | (4.20 mmol SiH/g) |
| 2.00 g | Silopren Chain Extender TP 3359 from GE Bayer |
| | (1.42 mmol SiH/g) |
| 9.00 g | Vinylsilicon VS 50 from Hanse Chemical, an alpha/omega- |
| | Divinylpolydimethylsiloxan with 50 mPa * s |
| | (0.63 mmol Vinyl/g) |
| 10.00 g | Vinylsilicon VS 10,000 from Hanse Chemical, an alpha/omega- |
| | Divinylpolydimethylsiloxan with 10,000 mPa * s |
| | (0.05 mmol Vinyl/g) |
| 30.00 g | Silopren Base Mixture P300 from GE Bayer |
| | (0.05 mmol Vinyl/g) |

Catalyst Paste:

| | |
|---|---|
| 40.00 g | Silopren Base Mixture P1,300 from GE Bayer |
| | (0.06 mmol Vinyl/g) |
| 0.30 g | Catalyst preparation (90 weight % alpha/omega |
| | divinylpolydimethylsiloxan with 1,000 mPa * s; |
| | 10 weight % catalyst complex “Karstedt”; |
| | corresponding to 4 weight % pure Pt) |
| | (0.53 mmo]. Vinyl/g) |
| 10.00 g | Vinylsilicon VS 50 from Hanse Chemical, an alpha/omega- |
| | Divinylpolydimethylsiloxan with 50 mPa * s |
| | (0.63 mmol Vinyl/g) |
| 0.025 g | Inhibitor PTS-I 27 (DVTMDS) from Wacker Chemical |
| | (10.75 mmol Vinyl/g) |
| 19.70 g | Vinylsilicon VS 10,000 from Hanse Chemical, an alpha/omega- |
| | Divinylpolydimethylsiloxan with 10,000 mPa * s |
| | (0.05 mmol Vinyl/g) |
| 30.00 g | Silopren Base Mixture P300 from GE Bayer |
| | (0.05 mmol Vinyl/g) |

### Example 3

“Regular Body & Tensid” (SiH/Vinyl: 1.87)
Base Paste:

| | |
|---|---|
| 39.00 g | Silopren Base Mixture P1,300 from GE Bayer |
| | (0.06 mmol Vinyl/g) |
| 9.00 g | Silopren Crosslinker 4.3 from GE Bayer |
| | (4.20 mmol SiH/g) |
| 2.00 g | Silopren Chain Extender TP 3359 from GE Bayer |
| | (1.42 mmol SiH/g) |
| 9.00 g | Vinylsilicon VS 50 from Hanse Chemical, an |
| | alpha/omegaDivinylpolydimethylsiloxan with 50 mPa * s |
| | (0.63 mmol Vinyl/g) |
| 10.00 g | Vinylsilicon VS 10,000 from Hanse Chemical, an alpha/omega- |
| | Divinylpolydimethylsiloxan with 10,000 mPa * s |
| | (0.05 mmol Vinyl/g) |
| 30.00 g | Silopren Base Mixture P300 from GE Bayer |
| | (0.05 mmol Vinyl/g) |
| 1.00 g | IGEPAL BC 4 (Rhodia) |

Catalyst Paste:

| | |
|---|---|
| 40.00 g | Silopren Base Mixture P1,300 from GE Bayer |
| | (0.06 mmol Vinyl/g) |
| 0.30 g | Catalyst preparation (90 weight % alpha/omega |
| | divinylpolydimethylsiloxan with 1,000 mPa * s; |
| | 10 weight % 20 catalyst complex “Karstedt”; |
| | corr. to 4 weight % pure Pt) |
| | (0.53 mmol Vinyl/g) |
| 10.00 g | Vinylsilicon VS 50 from Hanse Chemical, an alpha/omega- |
| | 25 Divinylpolydimethylsiloxan with 50 mPa * s |
| | (0.63 mmol Vinyl/g) |
| 0.025 g | Inhibitor PTS-I 27 (DVTMDS) from Wacker Chemical |
| | (10.75 mmol Vinyl/g) |
| 19.70 g | Vinylsilicon VS 10,000 from Hanse Chemical, an alpha/omega- |
| | Divinylpolydimethylsiloxan with 10,000 mPa * s |
| | (0.05 mmol Vinyl/g) |
| 30.00 g | Silopren Base Mixture P300 from GE Bayer |
| | (0.05 mmol Vinyl/g) |

2. Measurement Results

Base paste and catalyst paste of all above-mentioned compositions were homogeneously mixed in equal amounts (50:50), cured and typical features of the resulting masses were determined as follows (if not mentioned otherwise, the methods as outlined herein above were applied for the measurements):

| | | Tear strength | Wetting | | Translucency |
|---|---|---|---|---|---|
| Comp. | consistency | [MPa] | angle | Shore A | [%] |
| A | 43 mm | 2.92 | >90° | 44 | 67.6 |
| | (type 3) | | | | |
| B | 39 mm | 4.76 | >90° | 43 | 67.4 |
| | (type 2) | | | | |
| C | 35 mm | 4.22 | 45° | 43 | 63.3 |
| | (type 2) | | | | |

All compositions A, B and C proved highly suitable in dental impression taking, as outlined above.

1. A method of dental impression taking, comprising the step of applying a polymeric material at least partially to the region to be reproduced by the impression, wherein the polymeric material is translucent.

2. A method according to claim 1, wherein the polymeric material exhibits translucency in the range of about 30% to about 100%.

3. The method according to claim 2, further comprising: identifying an irregularity, especially air inclusion(s) within and/or under said translucent polymeric material; and eliminating said irregularity before hardening of said translucent polymeric material.

4. A method as in claim 1, in which the process of dental impression taking is a process chosen from the group consisting of two-material-two-phase processes, two-material-one-phase processes, and one-material-one-phase processes.

5. A polymeric material for dental applications, especially for impression taking, wherein said polymeric material exhibits:
a translucency in the range of about 30% to about 100%;
a shore A hardness according to DIN 53505 in the range of about 20 to about 70; and
a tensile strength according to DIN 53504 in the range of about 0.2 MPa to about 7 MPa.

6. A polymeric material for dental applications, especially for impressing taking, wherein said polymeric material exhibits:
a translucency in the range of ≧40% to about 100%;
a shore A hardness according to DIN 53505 in the range of about 30 to about 60; and
a tensile strength according to DIN 53504 in the range of about 1 MPa to about 6 MPa.

7. A polymeric material for dental applications, especially for impression taking, wherein said polymeric material exhibits:
a translucency in the range of ≧50% to about 100%;
a shore A hardness according to DIN 53505 in the range of about 45 to about 55; and
a tensile strength according to DIN 53504 in the range of about 1.5 mPa to about 4.5 mPa.

8. A polymeric material according to claim 5, wherein said material exhibits a consistency according to DIN ISO 4823:2000 of type 1 to type 3.

9. A polymeric material according to claim 5, wherein said material exhibits a consistency according to DIN ISO 4823:2000 of type 2 to type 3.

10. A polymeric material according to claim 5, wherein said material exhibits a wetting angle of contact of less than about 50° after 2 minutes.

11. A polymeric material according to claim 5, wherein said material is a silicon-based material.

12. A polymeric material according to claim 11, wherein said silicone-based material is an addition cross-linked silicone material.

13. A kit of parts, comprising a translucent polymeric material as in claim 5, and an additional material which is non-translucent or translucent.

14. A dental impression which is at least partially translucent.

15. A dental impression according to claim 14 selected from the group consisting of (i) a key for temporary or definitive composite crowns, telescope crowns or bridges;
(ii) a key for composite facings or veneers;
(iii) a positioning key for orthodontic brackets;
(iv) a positioning key prior to insertion of a dental implant;
(v) an implant template matrix; and
(vi) a (pre) impression for build-up of anterior and posterior teeth in restorative dentistry.
